(19) United States
(12) Patent Application Publication
(10) Pub. No.: US 2007/0044587 A1
(43) Pub. Date: Mar. 1, 2007

(54) Driving device for differential

(75) Inventor: Jih-Kuei Cho, Pingjhen City (TW)

Correspondence Address: NIKOLAI & MERSEREAU, P.A., 900 SECOND AVENUE SOUTH, SUITE 820, MINNEAPOLIS, MN, 55402, US

(73) Assignee: Shine Far Metal Industry Co., LTD., Guanyin Township (TW)

(21) Appl. No.: 11/215,769

(22) Filed: Aug. 29, 2005

(51) Int. Cl. F16H 48/12

(52) U.S. Cl. 74/650

(57) ABSTRACT

A differential includes a case with which a gear set is received and the gear set includes a spiral gear. Two output shafts extend through the case so as to be connected to two wheels. An input shaft is connected to the differential and has a bevel gear which is engaged with the spiral gear and drives the spiral gear so as to reduce the noise during operation.

### FIELD OF THE INVENTION

The present invention relates to a driving device for a differential and the driving device includes a bevel gear for driving a spiral gear of the gear set.

### BACKGROUND OF THE INVENTION

A conventional differential for vehicles generally includes bevel gears at the input and output ends to transfer power out to rotate wheels. However, the bevel gears are difficult to manufactured and expensive than the conventional gears. Besides, when two bevel gears are engaged with each other and rotate, an obvious noise is one of the main concerns for the users.

The present invention intends to provide a driving device which includes a input shaft and a bevel gear is connected thereto, the bevel gear is directly engaged with a spiral gear of the gear set in the differential so as to reduce noise during operation.

### SUMMARY OF THE INVENTION

The present invention relates to a differential that comprises a case and a gear set is received therein which includes a spiral gear. Two output shafts extend through the case so as to be connected to two wheels. An input shaft is connected to the differential and has a bevel gear which is engaged with the spiral gear and drives the spiral gear.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the differential of the present invention;

FIG. 2 is a top cross sectional view of the differential of the present invention;

FIG. 3 is a side cross sectional view of the differential of the present invention;

FIG. 4 shows the driving device of the present invention, and

FIG. 5 shows the differential is connected to two wheels and a power transmission shaft.

### DETAILED DESCRIPTION OF THE PREFERRED EMBODIMENT

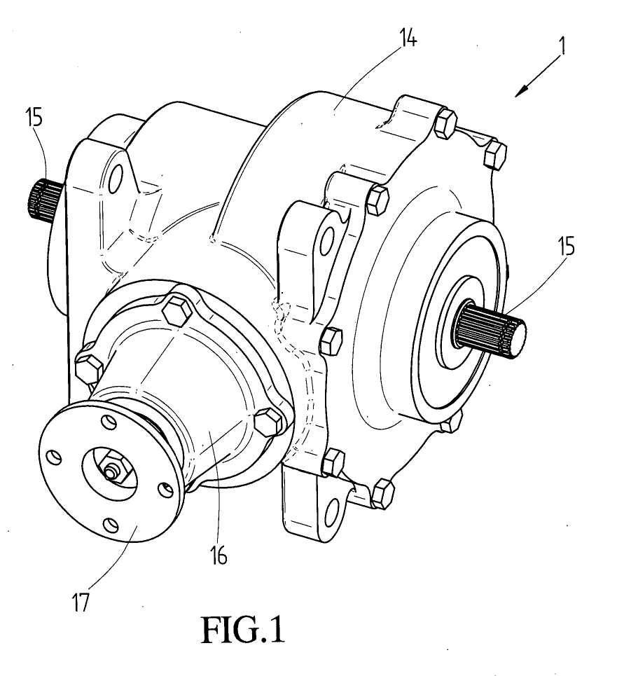

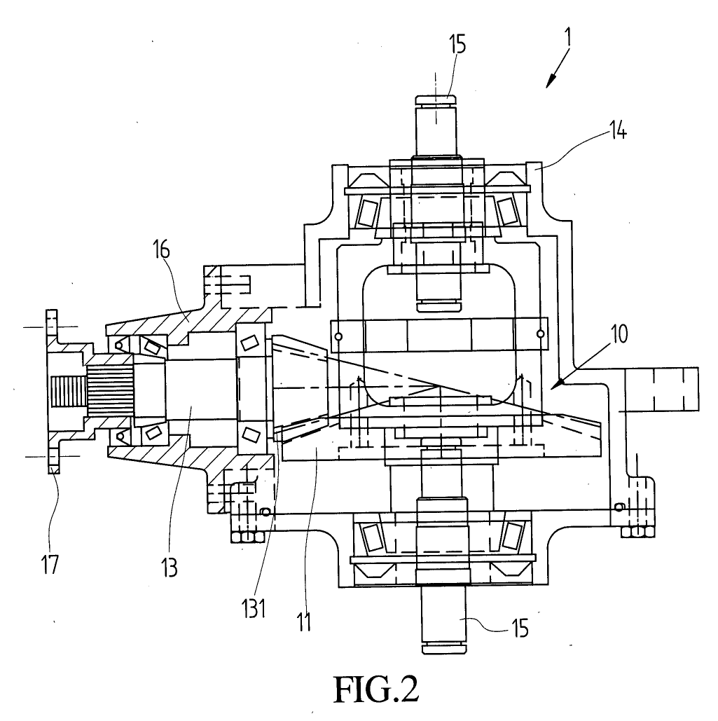

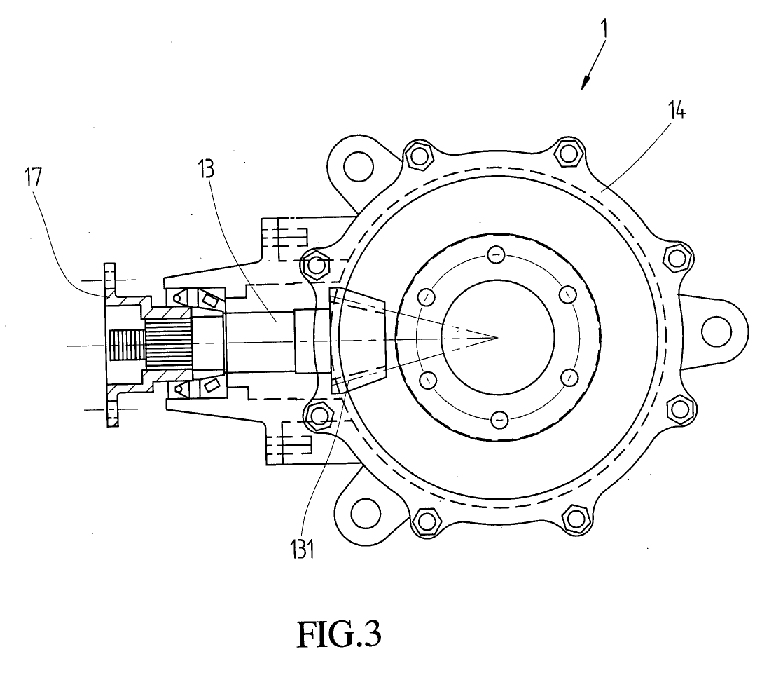

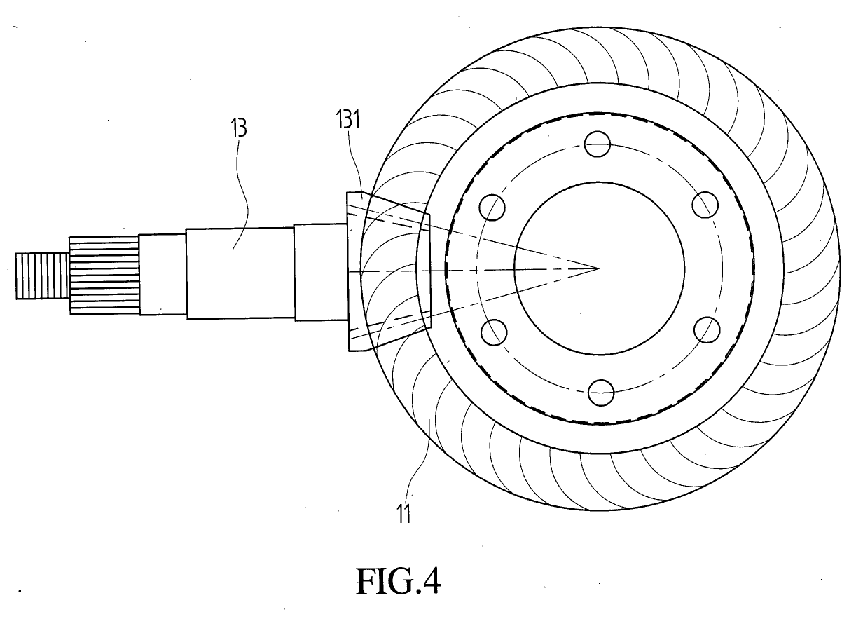

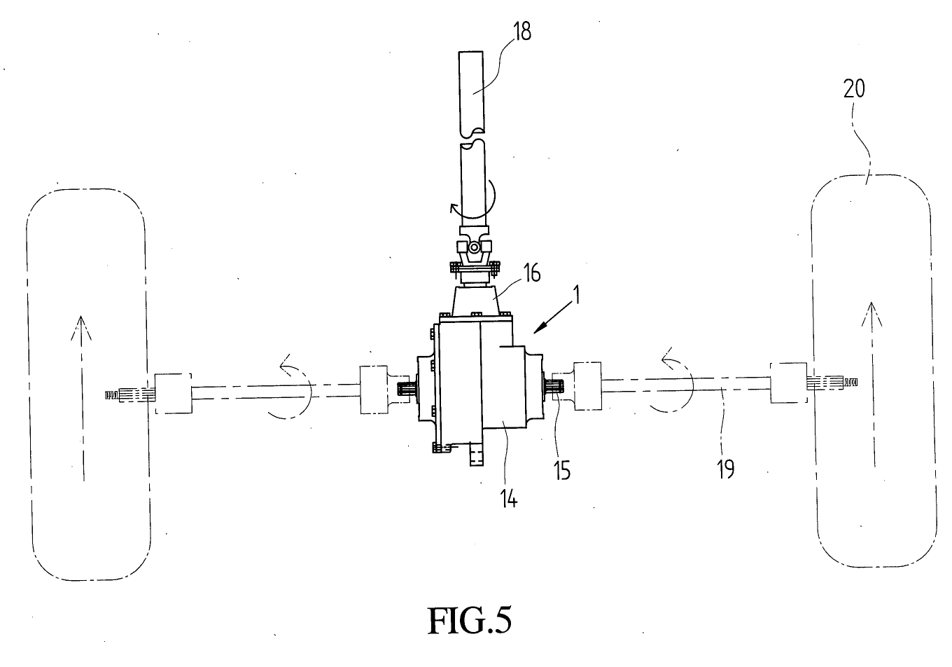

Referring to FIGS. 1 to 5, the differential 1 of the present invention comprises a case 14 and a gear set 10 is received in the case 14. The gear set 10 includes a spiral gear 11. Two output shafts 15 extend through the case 14 so as to be connected to two respective transmission shafts 19 and two wheels 20 as shown in FIG. 5.

An input shaft 13 is connected to the differential and has a bevel gear 131 which is engaged with the spiral gear 11 and directly drives the spiral gear 11. The input shaft 13 extends through a cover 16 which is connected to the case 14. A connection disk 17 is connected to the cover 16 such that a power transmission shaft 18 connected to engine (not shown) is connected to the input shaft 13 via the connection disk 17.

When the power from the engine is transferred to the input shaft 13 via the power transmission shaft 18, the bevel gear 131 drives the spiral gear 11 so as to dispense power to the two output shafts 15 to drive the wheels 20.

It is noted that the operation between the bevel gear 131 and the spiral gear 11 generates less noise than two bevel gears as disclosed for the conventional differential. The spiral gear 11 is also easily to be manufactured and installed.

While we have shown and described the embodiment in accordance with the present invention, it should be clear to those skilled in the art that further embodiments may be made without departing from the scope of the present invention.

What is claimed is:

1. A differential comprising:
a case and a gear set received in the case, the gear set including a spiral gear, two output shafts extending through the case, and
an input shaft connected to the differential and has a bevel gear which is engaged with the spiral gear and drives the spiral gear.

2. The differential as claimed in claim 1, wherein the input shaft extends through a cover which is connected to the case, a connection disk is connected to the cover.

3. The differential as claimed in claim 1, wherein a power transmission shaft is connected to the input shaft.
